(19) United States
(12) Patent Application Publication
(10) Pub. No.: US 2024/0273557 A1
(43) Pub. Date: Aug. 15, 2024

(54) NFT-ECO GENERATED BASED ON CARBON FOOTPRINT REDUCTION FROM SELECTION OF NEW VEHICLE

(71) Applicant: Toyota Connected North America, Inc., Plano, TX (US)

(72) Inventors: Olarinre Salako, Little Elm, TX (US); Danny Bargas, Coppell, TX (US); Varun Prasad, Dallas, TX (US); Daniel E. Holman, Allen, TX (US); Shravanthi Denthumdas, Frisco, TX (US); Will Hargis, Celina, TX (US); David Tsai, Irvine, CA (US); Jennifer Lerman, Dallas, TX (US); Brian Kursar, Fairview, TX (US)

(73) Assignee: Toyota Connected North America, Inc., Plano, TX (US)

(21) Appl. No.: 18/107,781

(22) Filed: Feb. 9, 2023

(51) Int. Cl. G06Q 30/0202; H04L 12/40

(52) U.S. Cl. CPC G06Q 30/0202; H04L 12/40; H04L 2012/40215; H04L 2012/40273

(57) ABSTRACT

A method for providing an NFT includes receiving CAN data from a current vehicle of a user, receiving, with the computing device, a specification of a new vehicle of the user, calculating an estimated carbon footprint based on CAN data from the current vehicle, calculating an expected carbon footprint based on the specification of the new vehicle and driving behavior defined by the CAN data from the current vehicle, determining a difference between the estimated carbon footprint and the expected carbon footprint, qualifying the new vehicle for the NFT, in response to determining that the difference is greater than a threshold value and the expected carbon footprint is less than the estimated carbon footprint, in response to qualifying the new vehicle for the NFT, executing an NFT design process, and causing the NFT generated by the NFT design process to be delivered to the user.

### TECHNICAL FIELD

The present specification relates to systems and methods for providing a Non-Fungible Token (“NFT”) ECO as an add-on to a vehicle purchase.

### BACKGROUND

An NFT is a non-interchangeable unit of data stored on a blockchain, a form of digital ledger, that can be sold and traded, and they have been used as a speculative asset. Types of NFT data units may be associated with digital files such as photos, videos, and audio. Because each token is uniquely identifiable, NFTs differ from blockchain cryptocurrencies, such as Bitcoin. NFT ledgers claim to provide a public certificate of authenticity or proof of ownership, but the legal rights conveyed by an NFT can be uncertain. Currently, NFTs primarily exist as the digital answer to collectibles with an authentic certificate created by blockchain technology.

As vehicle technology advances and vehicles become more environmentally friendly, there is an opportunity to improve the conversion to environmentally friendly vehicles and tracking of the conversion with a unique NFT provisioning process.

### SUMMARY

In one embodiment, a method for providing an NFT-ECO as an add-on to a vehicle purchase is disclosed. The method includes receiving, with a computing device, CAN data from a current vehicle of a user, receiving, with the computing device, a specification of a new vehicle for purchase by the user, calculating an estimated carbon footprint based on CAN data from the current vehicle, calculating an expected carbon footprint based on the specification of the new vehicle and driving behavior defined by the CAN data from the current vehicle, determining a difference between the estimated carbon footprint and the expected carbon footprint, qualifying the new vehicle for the NFT-ECO, in response to determining that the difference is greater than a threshold value and the expected carbon footprint is less than the estimated carbon footprint, in response to qualifying the new vehicle for the NFT-ECO, executing an NFT design process, and causing the NFT-ECO generated by the NFT design process to be delivered to the user.

In some embodiments, a system for providing an NFT-ECO as an add-on to a vehicle purchase is disclosed. The system includes a computing device comprising a processor and a non-transitory processor readable medium storing instructions that when executed by the processor cause the computing device to receive CAN data from a current vehicle of a user, receive a specification of a new vehicle for purchase by the user, calculate an estimated carbon footprint based on CAN data from the current vehicle, calculate an expected carbon footprint based on the specification of the new vehicle and driving behavior defined by the CAN data from the current vehicle, determine a difference between the estimated carbon footprint and the expected carbon footprint, qualify the new vehicle for the NFT-ECO, in response to determining that the difference is greater than a threshold value and the expected carbon footprint is less than the estimated carbon footprint, in response to qualifying the new vehicle for the NFT-ECO, execute an NFT design process, and cause the NFT-ECO generated by the NFT design process to be delivered to the user.

In some embodiments, a computer program product for providing an NFT-ECO as an add-on to a vehicle purchase is disclosed. The computer program product includes machine-readable instructions stored on a non-transitory computer readable memory, which when executed by a computing device, causes the computing device to carry out steps comprising receiving CAN data from a current vehicle of a user, receiving a specification of a new vehicle for purchase by the user, calculating an estimated carbon footprint based on CAN data from the current vehicle, calculating an expected carbon footprint based on the specification of the new vehicle and driving behavior defined by the CAN data from the current vehicle, determining a difference between the estimated carbon footprint and the expected carbon footprint, qualifying the new vehicle for the NFT-ECO, in response to determining that the difference is greater than a threshold value and the expected carbon footprint is less than the estimated carbon footprint, in response to qualifying the new vehicle for the NFT-ECO, executing an NFT design process, and causing the NFT-ECO generated by the NFT design process to be delivered to the user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts an illustrative system for providing an NFT-ECO as an add-on to a vehicle purchase according to one or more embodiments shown and described herein.

FIG. 2 depicts an illustrative vehicle of a user according to one or more embodiments shown and described herein.

FIG. 3 depicts an illustrative computing device for providing the NFT-ECO as an add-on to a vehicle purchase according to one or more embodiments shown and described herein.

FIG. 4 depicts a flow diagram of an illustrative method for qualifying a vehicle for an NFT-ECO and providing the NFT-ECO as an add-on to a vehicle purchase according to one or more embodiments shown and described herein.

### DETAILED DESCRIPTION

Embodiments disclosed herein relate to systems and methods for providing a Non-Fungible Token (“NFT”) ECO as an add-on to a vehicle purchase. The NFT-ECO is a unique, personalized token for interested and qualified customers as an add-on item to their vehicle purchase. It is based on the carbon footprint reduction that is determined by calculating the change from a current vehicle to a new, more efficient, vehicle with attendant lower carbon footprint. In some embodiments, the NFT-ECO includes unique artwork such as a scene of mature trees printed on it. The number of trees or another means of quantification represents the reduction in the number of mature trees required to absorb the CO₂ emission of the previous vehicle as compared with the new vehicle and the previous vehicle between or example, of the new, more efficient, vehicle.

Embodiments described herein include a system and method by which purchasers of a new, more efficient vehicle may determine whether they qualify for an NFT-ECO with their purchase and potions to customize their NFT-ECO. As described in more detail herein, the NFT-ECO includes unique artwork and may be implemented on various products associated with the purchase of their vehicle, such as a key fob, a floor mat, a sunshade, or the like.

In embodiments, a customer is prompted to select a certain powertrain (e.g., Fuel Cell Electric Vehicles (FCEV), Battery Electric Vehicles (BEV), Plugin Hybrid Electric Vehicles (PHEV), Hybrid Electric Vehicles (HEV)) from a powertrain selector. In other embodiments, the customer may be prompted to select and customize a vehicle including make, model, trim, packages, and additional features via an online vehicle build tool. The system also obtains CAN data from the customer's current vehicle to calculate the customer's monthly carbon footprint (X). The system compares the customer's current monthly carbon footprint (X) with an expected monthly carbon footprint (Y) for a new vehicle based on EPA standards and the monthly mileage of the customer. If Y is equal to or greater than X, the customer's selection of the powertrain is not qualified for NFT-ECO. In other words, the new vehicle does not provide a decrease in the customer's currently monthly carbon generation.

However, if Y is less than X, the customer's selection of the powertrain is qualified for NFT-ECO. In such instances, the system calculates, for example, an estimated number of trees equivalent to the carbon reduction. The system may also be configured to calculate other quantifiable equivalents that represent the carbon reduction provided by the customer's conversion to new, more efficient vehicle.

The system passes the estimated number of trees or other quantified equivalent information to an NFT design process. In some embodiments, the NFT design process is configured to allow the customer to further customize their NFT-ECO and select a product the NFT-ECO can be displayed on. For example, in some embodiments, the NFT design process includes printing the NFT-ECO on the back of a key fob. In some embodiments, the customer may also provide a personal photo to the NFT design process and the NFT design process may prepare a collage that includes a number of trees, the photo of the customer, and/or the photo of a new vehicle. Once complete, the system may cause the NFT-ECO to be generated in both a physical form and a digital from.

The NFT-ECO key fob has a digital version that will be stored as a static label in the CAN database. The digital version is not stored in a blockchain. By not storing in the blockchain the energy cost and carbon footprint of the storage and verification process is avoided. However, while the NFT-ECO is not a cryptocurrency such as Bitcoin, it could later be traded or sold for value. The system further causes the NFT-ECO to be delivered to the customer with or following the purchase of their new, more efficient vehicle.

It should be understood that the term “new” as used with respect to vehicle means new to the customer and not necessarily a newly manufactured vehicle. That is, new vehicle for the customer may be a newly manufactured vehicle or a previously owned vehicle (e.g., used vehicle).

The following will now describe these systems and methods in more detail with reference to the drawings and where like numbers refer to like structures.

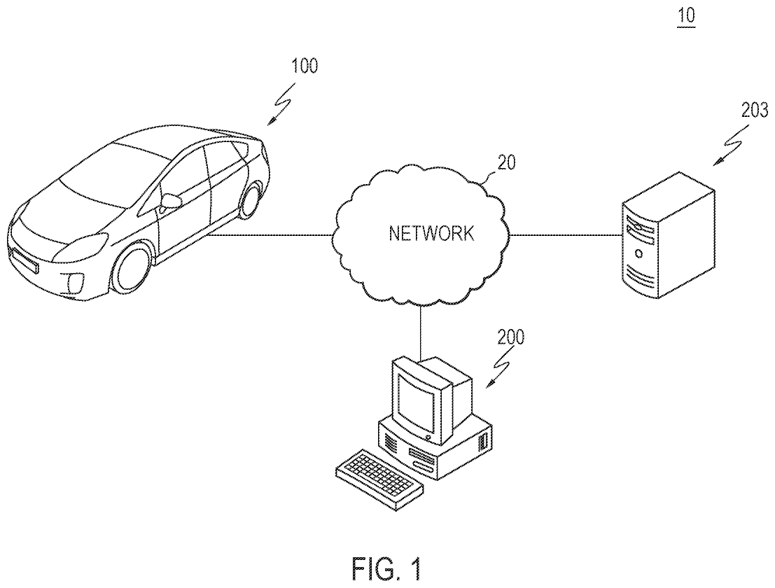

Referring to FIGS. 1-3, illustrative systems, computing devices, and vehicles interconnected to qualify a vehicle for an NFT-ECO and providing the NFT-ECO for as an add-on to a new vehicle purchase. FIG. 1 depicts the illustrative system 10 for providing an NFT-ECO as an add-on to a new vehicle purchase. In embodiments, the system includes a current vehicle 100, a computing device 200, and optionally a data server 203 interconnected with each other via a network 20. The network 20 may include a wide area network, such as the internet, a local area network (LAN), a mobile communications network, a public service telephone network (PSTN) and/or other network. The network 20 may be configured to electronically and/or communicatively connect the computing device 200, one or more data servers 203 optionally storing one or more databases of vehicle configurations and components for designing and building a new vehicle by a user. The current vehicle 100 is in communication with the computing device 200, for example, via the network 20, to provide CAN data to the computing device 200 whereby the computing device 200 may analyze and determine driving behaviors of the current vehicle in order to calculate an estimated carbon footprint of the current vehicle 100 of the user.

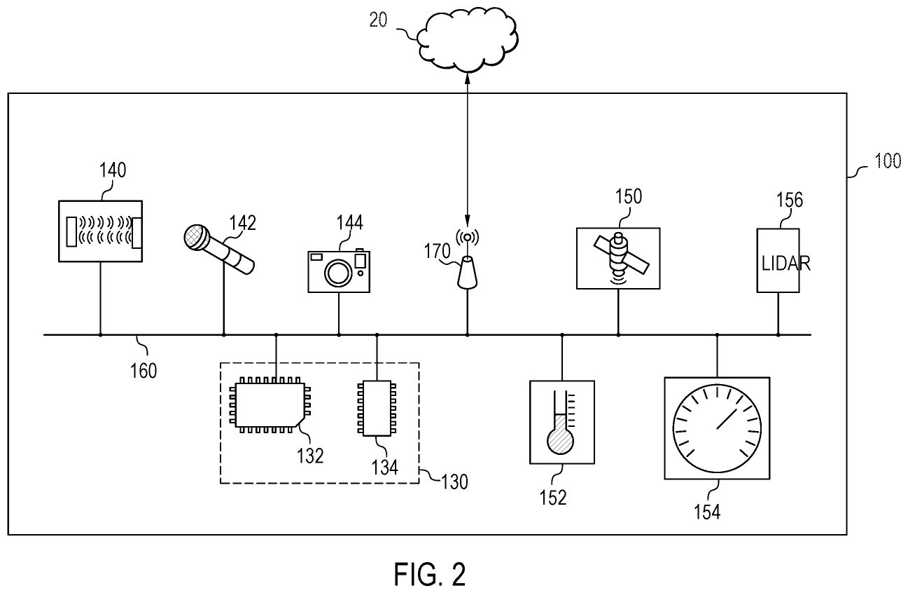

FIG. 2 depicts an example schematic of a vehicle 100 including sensor resources and a computing device (e.g., a controller area network, “CAN”). The vehicle 100 is a current vehicle of the user. In embodiments, the vehicle 100 is wireless connected to the network 20 so that CAN data can be exported to or queried by a computing device 200. In some embodiments, the vehicle 100 is not configured to wireless connect to the network 20, In such instances, an OBD2 scanning tool (not shown) can be utilized to interface with CAN of the vehicle 100 and record CAN data for importing manually to the computing device 200. CAN data includes information recorded by sensors and systems of the vehicle 100. Compiling CAN data provides a record of operations and locations in which the vehicle 100 traveled. The records can be analyzed to determine driving behaviors of a vehicle that may further be analyzed to calculate metrics such as fuel efficiency and/or carbon footprint of a vehicle in response to being operated by a user.

Referring specifically to the example vehicle 100 depicted in FIG. 2, the vehicle 100 includes a computing device 130 (e.g., a CAN) comprising a processor 132 and a non-transitory computer readable memory 134, a proximity sensor 140, a microphone 142, one or more cameras 144, a global positioning system (GPS) 150, weather sensors 152, a vehicle speed sensor 154, a LIDAR system 156, and network interface hardware 170. The vehicle 100 may include an actuator such as an engine, a motor, and the like to drive the vehicle. These and other components of the vehicle may be communicatively connected to each other via a communication path 160. The vehicle 100 may be autonomous and connected vehicles, each of which navigates its environment with limited human input or without human input.

The communication path 160 may be formed from any medium that is capable of transmitting a signal such as, for example, conductive wires, conductive traces, optical waveguides, or the like. The communication path 160 may also refer to the expanse in which electromagnetic radiation and their corresponding electromagnetic waves traverses. Moreover, the communication path 160 may be formed from a combination of mediums capable of transmitting signals to permit the transmission of electrical data signals to components such as processors, memories, sensors, input devices, output devices, and communication devices. Accordingly, the communication path 160 may comprise a bus. As used herein, the term “communicatively coupled” means that coupled components are capable of exchanging signals with one another such as, for example, electrical signals via conductive medium, electromagnetic signals via air, optical signals via optical waveguides, and the like.

The computing device 130 may be any device or combination of components comprising a processor 132 and non-transitory computer readable memory 134. The processor 132 may be any device capable of executing the machine-readable instruction set stored in the non-transitory computer readable memory 134. Accordingly, the processor 132 may be an electric controller, an integrated circuit, a microchip, a computer, or any other computing device. The processor 132 is communicatively coupled to the other components of the vehicle 100 by the communication path 160. Accordingly, the communication path 160 may communicatively couple any number of processors 132 with one another, and allow the components coupled to the communication path 160 to operate in a distributed computing environment. Specifically, each of the components may operate as a node that may send and/or receive data. While the embodiment depicted in FIG. 2 includes a single processor 132, other embodiments may include more than one processor 132.

The non-transitory computer readable memory 134 may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single non-transitory computer readable memory 134, other embodiments may include more than one memory module.

Still referring to FIG. 2, the proximity sensor 140 may be any device or combination of components capable of outputting a signal indicative of the presence or absence of an object within or near the vehicle 100. The proximity sensor 140 may include one or more sensors including, but not limited to, a camera, a laser distance sensor, an ultrasonic sensor, a radar sensor system, a motion sensor, a heat sensor, to determine the presence or absence of an object alongside, behind, or in front of the vehicle 100. The microphone 142 is coupled to the communication path 160 and communicatively coupled to the computing device 130. The microphone 142 may be any device capable of transforming a mechanical vibration associated with sound into an electrical signal indicative of the sound. The microphone 142 may be used to monitor sound levels for purposes such as determining the existence of traffic noise in the environment of the vehicle 100.

The vehicle 100 may further include one or more cameras 144. The one or more cameras 144 may enable a variety of different monitoring, detection, control, and/or warning systems within a vehicle 100. The one or more cameras 144 may be configured to provide a variety of information to the system about an environment. For example, image data captured by the one or more cameras 144 may provide information regarding location of operation of the vehicle 100 and the like.

Still referring to FIG. 2, a global positioning system, GPS 150, may be coupled to the communication path 160 and communicatively coupled to the computing device 130 of the vehicle 100. The GPS 150 is capable of generating location information indicative of a location of the vehicle 100 by receiving one or more GPS signals from one or more GPS satellites. The GPS signal communicated to the computing device 130 via the communication path 160 may include location information comprising a National Marine Electronics Association (NMEA) message, latitude and longitude data set, a street address, a name of a known location based on a location database, or the like. Additionally, the GPS 150 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas.

Some vehicles 100 may also include weather sensors 152, such as temperature sensors, precipitation gauges, wind meters, UV light sensors, or the like. The weather sensors 152 may be coupled to the communication path 160 and communicatively coupled to the computing device 130. The weather sensors 152 may be any device capable of outputting a signal indicative of a condition such as a temperature level, the presence or an amount of precipitation, the direction and/or speed of the wind, the presence and/or intensity of sunlight or the like. Information collected by the weather sensors 152 may provide the vehicle 100 and/or the system 10 with information that defines the present weather conditions, which may affect the efficiency of operation of the vehicle.

The vehicle 100 may also include a vehicle speed sensor 154 coupled to the communication path 160 and communicatively coupled to the computing device 130. The vehicle speed sensor 154 may be any sensor or system of sensors for generating a signal indicative of vehicle speed. For example, without limitation, a vehicle speed sensor 154 may be a tachometer that is capable of generating a signal indicative of a rotation speed of a shaft of the engine or a drive shaft. Signals generated by the vehicle speed sensor 154 may be communicated to the computing device 130 and converted a vehicle speed value. Signals generated by the vehicle speed sensor 154 can also be utilized to determine acceleration and braking activity and the level of aggressiveness of the driving operations. For example, the vehicle speed sensor 154 and the computing device 130 can determine when the vehicle 100 accelerates, maintains a constant speed, slows down or is comes to a stop

In some embodiments, the vehicle 100 may include a LIDAR system 156. The LIDAR system 156 is communicatively coupled to the communication path 160 and the computing device 130. A LIDAR system 156 or light detection and ranging is a system and method of using pulsed laser light to measure distances from the LIDAR system 156 to objects that reflect the pulsed laser light. The LIDAR system 156 can be used by vehicle 100 to provide detailed 3D spatial information for the identification of objects near the vehicle 100, as well as the use of such information in the service of systems for vehicular mapping, navigation and autonomous operations, especially when used in conjunction with geo-referencing devices such as GPS 150 or a gyroscope-based inertial navigation unit (INU, not shown) or related dead-reckoning system, as well as non-transitory computer readable memory 134 (either its own or memory of the computing device 130).

Still referring to FIG. 2, vehicles 100 are now more commonly equipped with vehicle-to-vehicle or vehicle-to-infrastructure communication systems. Some of the systems rely on network interface hardware 170. The network interface hardware 170 may be coupled to the communication path 160 and communicatively coupled to the computing device 130. The network interface hardware 170 may be any device capable of transmitting and/or receiving data with a network 20. The network interface hardware 170 enables a vehicle 100 to communicate CAN data to the computing device 200 wirelessly.

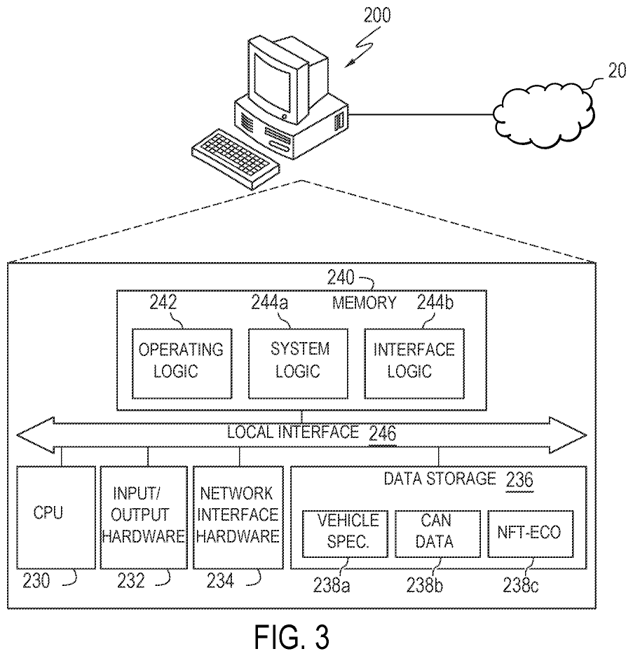

Turning to FIG. 3, an illustrative schematic of a computing device 200 configured to qualify a vehicle for an NFT-ECO and provide the NFT-ECO for as an add-on to a new vehicle purchase is depicted. The computing device 200 generally includes a display, a processing unit and an input device, each of which may be communicatively coupled together and/or to the network 20. As illustrated in FIG. 3, the computing device 200 includes a processor 230, input/output hardware 232, network interface hardware 234, a data storage component 236, which may store a vehicle specification 238a for a new vehicle, CAN data 238b from a current vehicle 100, and NFT-ECO designs 238c, and a memory component 240. The memory component 240 may be machine readable memory (which may also be referred to as a non-transitory processor readable memory or non-transitory processor readable medium). The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, system logic 244a for qualifying a new vehicle for an NFT-ECO and providing the NFT-ECO as an add-on to the purchased on the new vehicle 100 as described herein, and interface logic 244b for implementing one or more of the interactive interfaces such as an interface with a user and an interface for the NFT design process as described herein (each of which may be embodied as a computer program, firmware, or hardware, as an example). A local interface 246 is also included in FIG. 3 and may be implemented as a bus or other interface to facilitate communication among the components of the computing device 200.

The processor 230 may include any processing component(s) configured to receive and execute programming instructions (such as from the data storage component 236 and/or the memory component 240). The instructions may be in the form of a machine readable instruction set stored in the data storage component 236 and/or the memory component 240 or as a computer program product that when installed with the computing device 200 causes the computing device 200 carry out steps defined by the instructions. The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, Wi-Fi card, WiMax card, mobile communications hardware, and/or other hardware for communicating with other networks and/or devices.

It should be understood that the data storage component 236 may reside local to and/or remote from the computing device 200 and may be configured to store one or more pieces of data for access by the computing device 200 and/or other components. As illustrated in FIG. 2, the data storage component 236 may store a vehicle specification 238a for a new vehicle, CAN data 238b from a current vehicle 100, and NFT-ECO designs 238c.

The vehicle specification 238a for a new vehicle may include a set of user defined features including make, model, trim, packages, and additional features. The CAN data 238b is data received from a vehicle 100 and stored for use by the computing device 200. The CAN data 238b is analyzed by the computing device 200 to determine driving behaviors of the current vehicle in order to calculate an estimated carbon footprint of the current vehicle of the user. Additionally, the driving behaviors that are determined for the current vehicle can be applied to a new vehicle defined by the vehicle specification 238a of the new vehicle to estimate an expected carbon footprint of the new vehicle when it will be driven by the user. For example, simulations or other analysis tools can be used calculate the expected carbon footprint of the new vehicle based on the driving behaviors. The data storage component also includes NFT-ECO designs 238c. The NFT-ECO designs 238c include art or graphics that may be used to generate a unique NFT-ECO as well as storing a rendering of an NFT-ECO before it is manifested onto tangible objects such as a key fob, floor mat, sunshade, or the like or transferred to the non-transitory computer readable memory 134 of the CAN on the new vehicle.

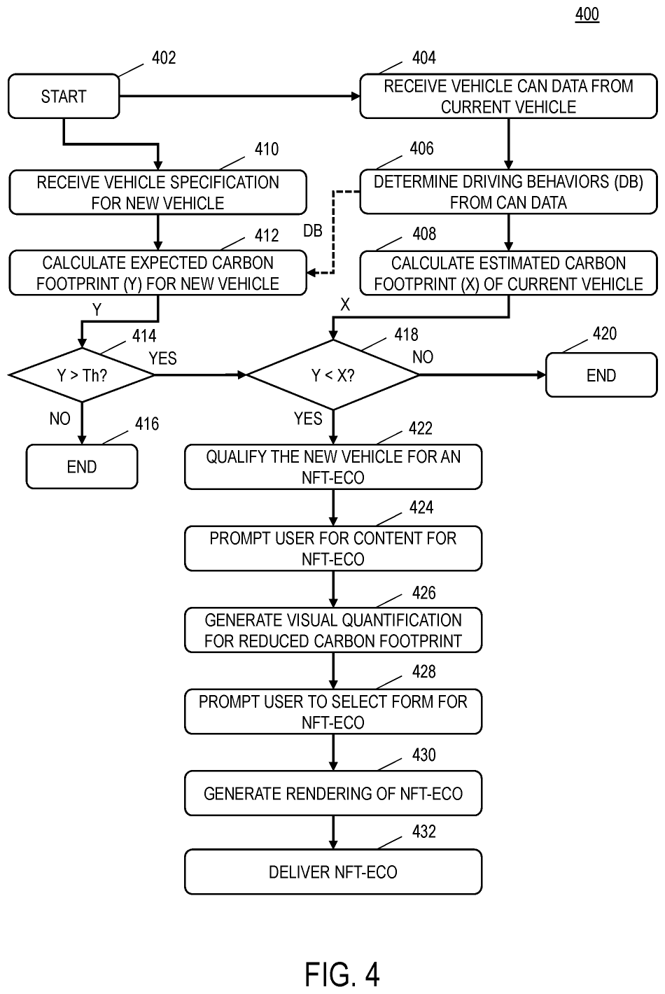

Methods implemented by the computing device 200 will now be described in more detail with respect to the flow diagram 400 depicted in FIG. 4.

FIG. 4 depicts a flow diagram of a method for qualifying a new vehicle for an NFT-ECO and once qualified, providing the NFT-ECO to the user with the purchase of the new vehicle. The method depicted in FIG. 4 is described with reference to FIGS. 1-3. The computing device 200 may implement embodiments of the method that are described herein.

At block 402, the computing device provides a user interface via a display for a user to start the process of determining whether a new vehicle the user is considering for purchase qualifies for an NFT-ECO. Once the user inputs information regarding their current vehicle, the process proceeds to block 404 and 410. At block 404, the computing device 200 receives vehicle CAN data 238b from the current vehicle of the user. In embodiments, the CAN data 238b is transmitted to the computing device 200 via the network 20. In some embodiments, the user may download the CAN data 238b from the CAN of their current vehicle and upload it to the computing device 200.

The CAN data is the processed by the computing device 200 at block 406. At block 406, the computing device 200 analyzes the CAN data 238b and determines driving behaviors (DB) from the CAN data 238b. The driving behaviors (DB) include parameterized driving events. The parameters include, for example, a fuel efficiency for a driving event, distance traveled, number of hard and easy acceleration and braking events, elevation changes, and the like. The driving behaviors (DB) are further used to calculate an estimated carbon footprint (X) of the current vehicle for an interval of time. The interval of time may be a year, a month, a week, a day, or some other interval of time. A specification for the current vehicle includes an EPA estimated grams of CO2 per mile value. As an example, the computing device 200 calculates the estimated carbon footprint (X) for the current vehicle by obtaining a mileage driven value from the CAN data 238b of the current vehicle and multiplying the mileage driven value by the EPA estimated grams of CO2 per mile value for the current vehicle. For example, if the EPA estimated grams of CO2 per mile value is 636 and the mileage driven value is 12,000 miles for an interval of time (e.g., 1 year), the estimated carbon footprint (X) is 7,632,000 grams of CO2.

The computing device 200 may adjust this calculation by analyzing additional data of the CAN data that affects the efficiency of a vehicle. For example, a driving behavior may indicate that the 12,000 miles driving during the year were aggressively driven, primarily highway miles, primarily city miles, or another characterization that may affect the generation of CO2 of the current vehicle. For example, if the vehicle was primarily driven on the highway, the CO2 generated per mile may be less than the CO2 generated per mile by a vehicle that is primarily driven at lower speeds with many stop and go events on city streets. The navigation data, vehicle speed, image data and the like from the CAN data 238b can provide context for the miles driven by the current vehicle.

At block 410, the computing device 200 receives a vehicle specification 238a for a new vehicle. The vehicle specification 238a may indicate a powertrain, a make, a model, a trim, packages, and/or additional features selected by a user using an online vehicle build tool. At block 412, the computing device 200 utilizes the CAN data 238b, for example, miles driven by a user in their current vehicle for the interval of time, and the determined driving behaviors (DB) to calculate the expected carbon footprint (Y) for the new vehicle.

The vehicle specification 238a for the new vehicle includes an EPA estimated grams of CO2 per mile value. As an example, the computing device 200 calculates the expected carbon footprint (Y) for the new vehicle by multiplying the mileage driven of the current vehicle by the EPA estimated grams of CO2 per mile value for the new vehicle. For example, if the EPA estimated grams of CO2 per mile value is 477 and the mileage driven value is 12,000 miles for an interval of time (e.g., 1 year), the expected carbon footprint (Y) is 5,724,000 grams of CO2. The computing device 200 can make adjustments to the expected carbon footprint (Y) in a similar manner as described with reference to block 408.

After calculating, the expected carbon footprint (Y) for the new vehicle, the computing device 200, at block 414, may determine whether the expected carbon footprint (Y) is greater than a threshold value. It is noted that some implementations of the method may not include the process of block 414. If the expected carbon footprint (Y) is not greater than the threshold value, “NO” at block 414, the qualification process proceeds to block 416, where the method terminates, for example, with a notification to the user that the new vehicle as configured does not qualify for an NFT-ECO. However, if the expected carbon footprint (Y) is greater than the threshold value (Th), “YES” at block 414, the qualification process proceeds to block 418.

At block 418, the computing device 200, determines whether the expected carbon footprint (Y) is less than the estimated carbon footprint (X). If the expected carbon footprint (Y) is not less than the estimated carbon footprint (X), “NO” at block 418, the qualification process proceeds to block 420, where the method terminates. At block 420, the computing device 200 may generate and provide a notification to the user that the new vehicle as configured does not qualify for an NFT-ECO. However, if the expected carbon footprint (Y) is less than the estimated carbon footprint (X), “YES” at block 418, the qualification process proceeds to block 422.

In some embodiments, the computing device 200 determines a difference between the estimated carbon footprint (X) and the expected carbon footprint (Y) and then determines if the difference is greater than a threshold value (Th). If the difference is greater than the threshold value (Th), then the new vehicle may be qualified for an NFT-ECO and the process proceeds to block 422.

At block 422, the computing device 200 qualifies the new vehicle for an NFT-ECO. In some embodiments, in response to the qualifying the new vehicle for an NFT-ECO, the computing device 200 automatically renders an NFT-ECO for the user. However, in other embodiments, the process proceeds to block 424, where the computing device 200 executes an NFT design process (e.g., blocks 424-430). At block 424, the computing device 200 prompts the user through a user interface to optionally provide content for the NFT-ECO. The user can provide content such as an image or other data to incorporate into the NFT-ECO. At block 426, the computing device 200 generates a visual quantification of the reduction in carbon footprint of the new vehicle compared to the current vehicle based on the estimated carbon footprint (X) and the expected carbon footprint (Y). For example, the reduction in carbon footprint is determined by computing the difference between the estimated carbon footprint (X) and the expected carbon footprint (Y). The quantification of the reduction in carbon footprint may include determining a number of mature trees needed to absorb the emitted reduction in the amount of CO2. For example, a mature tree can absorb about 22 kilograms of CO2 from the atmosphere per year. Following the above example, the reduction in the amount of CO2 is 1,908 kg of CO2 in a year. Thus, dividing the reduction by the amount a mature tree can absorb in a year results in about 87 trees in a year, or about 7 trees a month. As such, a visual quantification of the reduction in carbon footprint may be an image of seven trees or a forest of 87 trees.

At block 428, the computing device 200 prompts a user to select the form in which they desire to receive the NFT-ECO. For example, the user may select a tangible object with the NFT-ECO and/or a digital version. Based on the selection, the computing device 200 generates a rendering of the NFT-ECO at block 430. The user may then further edit the rendering before accepting it as the NFT-ECO to include in their purchase of the new vehicle. At block 432, the computing device 200 delivers the NFT-ECO to the user. In some embodiments, the computing device 200 causes the NFT-ECO to be stored in the non-transitory computer readable memory 134 of the new vehicle. In some embodiments, the computing device 200 causes the NFT-ECO causes the NFT-ECO to be formatted and applied to the object the user selected, for example, the key fob, a floor mat, a sunshade or the like.

In some embodiments, the new vehicle may be an autonomous driving vehicle, and the new vehicle controls the operation of vehicles, such as speeds, accelerations of the autonomous driving vehicle to meet the EPA estimated grams of CO2 per mile value that is used to calculate the expected carbon footprint (Y) for the new vehicle. For example, if an average actual carbon footprint for the new vehicle is greater than the expected carbon footprint, the new vehicle may adjust the speed or acceleration or change routes to reduce an average carbon footprint.

It should be understood that steps of the aforementioned process may be omitted or performed in a variety of orders while still achieving the object of the present disclosure. The functional blocks and/or flowchart elements described herein may be translated onto machine-readable instructions. As non-limiting examples, the machine-readable instructions may be written using any programming protocol, such as: descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

It should now be understood that embodiments described herein are directed to providing a NFT-ECO for qualifying new vehicles as an add-on to the purchase of the new vehicle. The NFT-ECO is a unique, personalized token for interested and qualified customers as an add-on item to their vehicle purchase. It is based on the carbon footprint reduction that is determined by calculating the change from a current vehicle to a new, more efficient, vehicle with attendant lower carbon footprint.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing a Non-Fungible Token (NFT) as an add-on to a vehicle comprising:
receiving, with a computing device, Controller Area Network (CAN) data from a current vehicle of a user;
receiving, with the computing device, a specification of a new vehicle of the user;
calculating an estimated carbon footprint based on CAN data from the current vehicle;
calculating an expected carbon footprint based on the specification of the new vehicle and driving behavior defined by the CAN data from the current vehicle;
determining a difference between the estimated carbon footprint and the expected carbon footprint;
qualifying the new vehicle for the NFT, in response to determining that the difference is greater than a threshold value and the expected carbon footprint is less than the estimated carbon footprint;
in response to qualifying the new vehicle for the NFT, executing an NFT design process; and
causing the NFT generated by the NFT design process to be delivered to the user.

2. The method of claim 1, wherein the NFT design process comprises:
prompting the user via a user interface for content for the NFT,
determining a visual quantification of a reduction in carbon footprint of the new vehicle compared to the current vehicle based on the estimated carbon footprint and the expected carbon footprint,
prompting the user to select a product to implement the NFT on, and
generating a rendering of the NFT on the selected product, wherein the NFT is a unique work comprising the content and the visual quantification.

3. The method of claim 1, wherein the estimated carbon footprint and the expected carbon footprint are calculated for an interval of time.

4. The method of claim 3, wherein the interval of time is a year, a month, a week, or a day.

5. The method of claim 1, wherein the NFT design process comprises implementing the NFT on a tangible object.

6. The method of claim 5, wherein the tangible object is at least one of a key fob, a floor mat, or a sunshade.

7. The method of claim 1, wherein the NFT design process comprises generating a digital version of the NFT and storing the NFT in a memory unit of the new vehicle.

8. A system for providing an NFT as an add-on to a vehicle comprising:
a computing device comprising a processor and a non-transitory processor readable medium storing instructions that when executed by the processor cause the computing device to:
receive CAN data from a current vehicle of a user;
receive a specification of a new vehicle of the user;
calculate an estimated carbon footprint based on CAN data from the current vehicle;
calculate an expected carbon footprint based on the specification of the new vehicle and driving behavior defined by the CAN data from the current vehicle;
determine a difference between the estimated carbon footprint and the expected carbon footprint;
qualify the new vehicle for the NFT, in response to determining that the difference is greater than a threshold value and the expected carbon footprint is less than the estimated carbon footprint;
in response to qualifying the new vehicle for the NFT, execute an NFT design process; and
cause the NFT generated by the NFT design process to be delivered to the user.

9. The system of claim 8, wherein the NFT design process comprises:
prompting the user via a user interface for content for the NFT,
determining a visual quantification of a reduction in carbon footprint of the new vehicle compared to the current vehicle based on the estimated carbon footprint and the expected carbon footprint,
prompting the user to select a product to implement the NFT on, and
generating a rendering of the NFT on the selected product, wherein the NFT is a unique work comprising the content and the visual quantification.

10. The system of claim 8, wherein the estimated carbon footprint and the expected carbon footprint are calculated for an interval of time.

11. The system of claim 10, wherein the interval of time is a year, a month, a week, or a day.

12. The system of claim 8, wherein the NFT design process comprises generating the NFT on a tangible object.

13. The system of claim 12, wherein the tangible object is at least one of a key fob, a floor mat, or a sunshade.

14. The system of claim 8, wherein the NFT design process comprises generating a digital version of the NFT and storing the NFT in a memory unit of the new vehicle.

15. A computer program product for providing an NFT as an add-on to a vehicle, the computer program product comprising machine-readable instructions stored on a non-transitory computer readable memory, which when executed by a computing device, causes the computing device to carry out steps comprising:
receiving CAN data from a current vehicle of a user;
receiving a specification of a new vehicle of the user;
calculating an estimated carbon footprint based on CAN data from the current vehicle;
calculating an expected carbon footprint based on the specification of the new vehicle and driving behavior defined by the CAN data from the current vehicle;
determining a difference between the estimated carbon footprint and the expected carbon footprint;
qualifying the new vehicle for the NFT, in response to determining that the difference is greater than a threshold value and the expected carbon footprint is less than the estimated carbon footprint;
in response to qualifying the new vehicle for the NFT, executing an NFT design process; and
causing the NFT generated by the NFT design process to be delivered to the user.

16. The computer program product of claim 15, wherein the NFT design process comprises:
prompting the user via a user interface for content for the NFT,
determining a visual quantification of a reduction in carbon footprint of the new vehicle compared to the current vehicle based on the estimated carbon footprint and the expected carbon footprint,
prompting the user to select a product to implement the NFT on, and
generating a rendering of the NFT on the selected product, wherein the NFT is a unique work comprising the content and the visual quantification.

17. The computer program product of claim 15, wherein the estimated carbon footprint and the expected carbon footprint are calculated for an interval of time.

18. The computer program product of claim 17, wherein the interval of time is a year, a month, a week, or a day.

19. The computer program product of claim 15, wherein the NFT design process comprises implementing the NFT on a tangible object, wherein the tangible object is at least one of a key fob, a floor mat, or a sunshade.

20. The computer program product of claim 15, wherein the NFT design process comprises generating a digital version of the NFT and storing the NFT in a memory unit of the new vehicle.
